(19) United States
(12) Patent Application Publication
(10) Pub. No.: US 2019/0208371 A1
(43) Pub. Date: Jul. 4, 2019

(54) TERMINAL FOR ESTABLISHING COMMUNICATIONS BY INTERNAL BROADCAST OF A GROUP

(71) Applicant: BULL SAS, Les Clayes-Sous-Bois (FR)

(72) Inventors: Aude MORISSET, REZE (FR); Angélique GALTIER, PARIS (FR); Julien FOURE, MONTROUGE (FR)

(21) Appl. No.: 16/306,785

(22) PCT Filed: Jun. 2, 2017
(86) PCT No.: PCT/EP2017/063551

§ 371 Date: Mar. 20, 2019

(30) Foreign Application Priority Data
Jun. 2, 2016 (FR) 1600894

(51) Int. Cl. H04W 4/08; H04W 76/11; H04W 88/02; H04M 1/725

(52) U.S. Cl. CPC H04W 4/08; H04W 76/11; H04M 1/72583; H04M 1/72563; H04W 88/023

(57) ABSTRACT

A terminal for establishing communications, the communications being broadcasts inside a group of users, a user of the terminal belonging to at least one group of users, the communication terminal including components for: associating a list of user identifiers with a group identifier, associating a plurality of properties with a user, associating a property activation value with each property, recording an identifier of a current group, recording a value of a current state, updating the value of the current state as a function of a user input, and adapting a display as a function of the identifier of the current group and the value of the current state.

### TECHNICAL FIELD OF THE INVENTION

The object of the invention is a communication terminal by broadcasting inside a group.

The field of the invention is that of communication devices, in particular that of communication devices that have to maximise a piece of information/area ratio, the piece of information including a plurality of users.

In the present text, by terminal and in particular by communication terminal, it is meant any communicating data processing device which includes, in a non-limiting way, so-called smart phones, tablets, desktop and laptop computers. The invention is however more particularly intended to transportable terminals such as those which are used in theatres of military operations.

### STATE OF PRIOR ART

In the state of the art, combatant and their supports are provided with information systems which enable data on a theatre of operation and troops which are deployed thereat to be viewed. In particular, these systems make it possible to display for a combatant:
his/her identifier;
his/her mission;
his/her operational capabilities.

This display is made overall for each combatant. Thus, if a piece of information is desired to be viewed for a unit including several combatants, all the members of the unit should be viewed and, for each member, the corresponding piece of information should be retained. At the end of the viewing sequence, an idea of the piece of information at the unit is obtained.

If time allows to take notes between each combatant, this solution is acceptable, but in stressful situation, for example in combat, it becomes impossible.

### DISCLOSURE OF THE INVENTION

The invention enables this problem to be solved by providing an overall viewing mode for a piece of information at a unit. The invention makes it possible with a screen to have an overall view of an aspect of a situation.

Therefore, one object of the invention is a terminal for establishing communications, the communications being broadcasts inside a group of users, a user of the terminal belonging to at least one group of users, the communication terminal including means for:
associating a list of user identifiers with a group identifier,
associating a plurality of properties with a user,
associating a property activation value with each property,
recording an identifier of a current group,
recording a value of a current state,
updating the value of the current state as a function of a user input,
adapting a display as a function of:
   the identifier of the current group,
   the value of the current state.

The invention has also the following characteristics to be considered according to the possible combinations with the object of the invention:
the terminal includes means for associating a property with all the values of the current state;
for a property, the terminal includes means for associating a colour value with each possible value of the property;
the terminal includes means for associating a zone of a screen with each user of a group of users;
the terminal includes means for associating a rendering mode with a property;
a rendering mode is selected from the list formed by at least: background, text, gauge.

### BRIEF DESCRIPTION OF THE FIGURES

Further characteristics and advantages of the invention will appear upon reading the description that follows, in reference to the appended figures, which illustrate:

FIG. 1: an illustration of an infrastructure enabling the invention to be implemented;

FIG. 2: an illustration of steps of the method according to the invention.

For more clarity, identical or similar elements are marked with identical reference signs throughout the figures.

The invention will be better understood upon reading the description that follows and upon examining the accompanying figures. These are given by way of indicating and in no way limiting purposes for the invention.

### DETAILED DESCRIPTION OF ONE EMBODIMENT

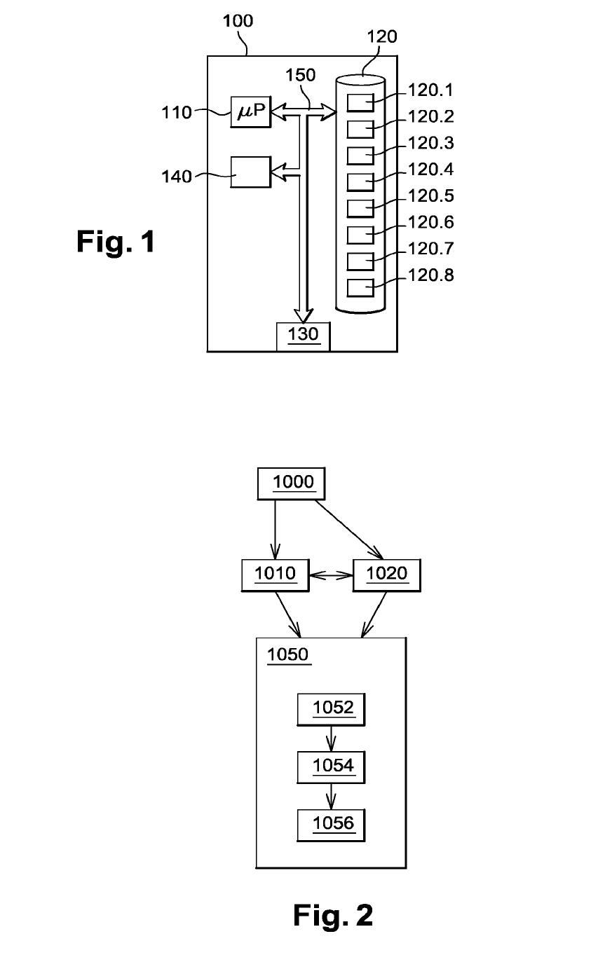

FIG. 1 shows a terminal 100 according to the invention. The terminal according to the invention includes:
a microprocessor 110;
storage means 120, for example a hard disc, a memory card or an integrated component, or a part of an integrated component, dedicated to data storage;
a communication interface 130, for example a communication card according to the Ethernet protocol. Other protocols are contemplatable as IP. The communication interface can be wired or wireless;
a screen 140, for example a tactile screen.

The microprocessor 110 of the terminal, the storage means 120 of the terminal, the communication interface 130 of the terminal and the screen 140 of the terminal are interconnected by a bus 150.

If an action is undertaken by a device, this action is actually made by a microprocessor of the device controlled by instruction codes recorded in a memory of the device. If an action is undertaken by an application, this action is actually made by a microprocessor of the device in a memory from which instruction codes corresponding to the application are recorded. When a device, or an application, emits a message, this message is emitted via a communication interface of said device or said application. In these cases, a device is real or virtual.

FIG. 1 shows that the storage means 120 include a plurality of zones. Each zone is structured to fulfil a function. Thus, the storage means of the terminal according to the invention include:
a zone 120.1 of group structured to associate a group identifier with a plurality of user identifiers, for example a table as described in the following;
a zone 120.2 of user description structured to associate a user identifier with a plurality of properties, each property being itself at least a property identifier, property value couple;
a zone 120.3 of properties to associate an activation value with each property, that is a value which is used to select all the properties having the same activation value. In practice, this amounts to providing in the recording structure a property to have at least two fields: a property identifier field and an activation value field;
a zone 120.4 of current group identifier which enables a group identifier to be recorded;
a zone 120.5 of current state which enables a value for a current state to be recorded. A value of a current state can be compared with an activation value;
a zone 120.6 including instruction codes for updating a current state according to an action of a user of the terminal according to the invention on an input peripheral of the terminal according to the invention, for example a tactile screen;
a zone 120.7 including a predetermined sequence of activation values, this sequence being used to update the zone 120.5 of the current state;
a zone 120.8 including instruction codes for adapting a display according to the identifier of the current group, and the value of the current group.

In the invention, an association of an identifier of a first object with a plurality of second objects can be made in several ways. For example:
a table including at least two columns is used, a first column including the identifier of the first object, a second column including an identifier of a second object. Therefore, there are in the table at least as many rows as second objects to be related to the first object. This is called a many-to-many relationship; or
in the structure of description of the second object, a field is provided to record an identifier of the first object. It is called a one-to-many relationship. That is not the preferred one here because it would mean, for example, that a user can only belong to one group; or
a hierarchical structure, of the XML file type is used. In this case, a list of identifiers of second objects is recorded as a child of a structure including an identifier of the first object.

A record structure of a property is a structure in memory which enables information to be associated, according to at least one of the previous association modes, with a property identifier.

The means for adapting the display includes instruction codes for implementing the following steps.

An initial step 1000 in which the group zone 120.1 is fed. Within the scope of the implementation of the invention on a military terminal, the groups correspond to the communication loops. In a more general case, it is an enrolment or inscription step in groups the list of which is known.

Step 1000 is followed by a step 1010 of activating a group in which a user uses an interface to select a group from the list fed in the next step. There is a default group which is that selected upon initialising the terminal. The step 1010 enables the current group zone 120.4 to be fed.

Step 1000 is also followed by a step 1020 of selecting an active state. In a preferred mode of the invention, it is made by activating an activator on a man-machine interface provided by the terminal according to the invention. This activation results in reading the value of the current state and then using the result of this reading to search for, in the predetermined sequence of activation values, the value next to the current value. This next value is then recorded as a current state. There is a default value of current state, it is the value of the current state.

If the value of the current group changes or if the value of the current state changes, then one proceeds to a step 1050 of adapting the display itself.

In the adaption step 1050, the following steps are made:
selecting 1052 data to be taken into account. The result of this selection is a user list, each user being associated with at least one property identifier, property value couple;
associating (1054) a distinct user zone of the terminal screen with each user selected. Such an association is made, for example, by dividing a predetermined zone of the screen by the number of users in the active group,
updating (1056) the screen zones as a function of the data.

For selecting 1052 the data, the users corresponding to the active group are first selected. Thereby, for each user selected, the associated properties corresponding to the value of the active state are selected.

In one alternative of the invention, a joker activation value which corresponds to all the values of the current state, is used. Thus, a property associated with this activation value is systematically selected.

In a basic version of the invention, a user zone is updated by the raw display of the property values regardless of whether these are character numbers or strings.

In one alternative of the invention, for a given property, a colour is associated with each possible value. It enables for example a background colour to be defined for the user zone. Such an association is made at the recording structure of the property which will be extended to allow the association management:
property identifier
property value
colour, or any other datum enabling a display to be adapted, as for example transparency, designating an image, a rendering mode . . . For example, a property is the user's connectivity. Such a connectivity can have four values:
direct connectivity: green is for example associated therewith;
indirect connectivity: orange is for example associated therewith;
out of range: orange is for example associated therewith;
alert: red is for example associated therewith.

A rendering mode is for example a gauge or a bar graph. In this case, for each property corresponding to this rendering mode, the method according to the invention calculates a gauge and displays it. For a gauge, the filling is calculated as a function of a maximum value which is recorded in the recording structure of the property.

A property which can be rendered as a gauge is for example a level of available ammunitions.

A current state is for example part of the following list:
identifier H: that is display of the identifiers of the users for the communication channel H;
tactics: for each user, a mission code is displayed: recognition, assault, retirement, medical evacuation, . . .
operational capabilities: for example the ammunition level.

1. A terminal for establishing communications, the communications being broadcasts inside a group of users, a user of the terminal belonging to at least one group of users, the communication terminal including means for:
associating a list of user identifiers with a group identifier,
associating a plurality of properties with a user,
associating a property activation value with each property,
recording an identifier of a current group,
recording a value of a current state,
updating the value of the current state as a function of a user input,
adapting a display as a function of:
the identifier of the current group,
the value of the current state.

2. The communication terminal according to claim 1, wherein the terminal includes means for:
associating a property with all the values of the current state.

3. The communication terminal according to claim 1 wherein, for a property, the communication terminal includes means for:
associating a colour value with each possible value of the property.

4. The communication terminal according to claim 1, comprising means for:
associating a zone of a screen with each user of a group of users.

5. The communication terminal according to claim 1, comprising means for:
associating a rendering mode with a property.

6. The communication terminal according to claim 5, wherein a rendering mode is selected from a list formed by at least: background, text, gauge.
